(19) United States
(12) Patent Application Publication
(10) Pub. No.: US 2005/0161650 A1
(43) Pub. Date: Jul. 28, 2005

(54) Cable installation

(76) Inventor: Ian Harley, Southampton (GB)

Correspondence Address: DILLION & YUDELL, LLP, 8911 N CAPITAL OF TEXAS HWY, SUITE 2110, AUSTIN, TX, 78759, US

(21) Appl. No.: 10/511,824

(22) PCT Filed: Feb. 14, 2003
(86) PCT No.: PCT/GB03/00667

(51) Int. Cl. H02G 1/08

(52) U.S. Cl. 254/134.3 R; 294/1.1

(57) ABSTRACT

An apparatus for gripping cables is disclosed. The apparatus for gripping a cable includes an elongated housing for slidably receiving the cable axially thereof. The housing is configured to permit an end of the cable to leave the housing and be received back by the housing such that the cable forms a loop. The apparatus for gripping cables also includes means for securing at least a part of the cable received back by the housing.

### BACKGROUND OF THE INVENTION

1. Technical Field

The present invention relates to cable installation in general, and, in particular, to an apparatus for gripping cables.

2. Description of Related Art

Twisted pair copper cables have traditionally been used within buildings to carry voice and data to equipment such as computers, telephones and the like. Typically, hundreds of meters of cables have to be run above ceiling or under floor to reach various equipment.

Referring now to the drawings and in particular to FIG. 1, there is graphically illustrated an apparatus for gripping cables, according to the prior art. Cable installers typically pull a cable 20 from a drum 10 containing approximately 500 meters of cable 20. The end of cable 20 is placed within a pulling sock 30 that is made of a steel lattice. As cable 20 is being pulled, pulling sock 30 tightens around a specific length of cable 20 such that cable 20 is securely gripped by pulling sock 30.

Potential damages to a cable, such as cable 20, can be caused by the over-stretching of twisted pair conductors inside the insulating sheath of the cable. Over-stretching causes the distance between the twisted pairs to be reduced, giving rise to an increase in cross-talk and reducing the effectiveness of the cable. Thus, a palling fuse 40 or a similar device is used to limit the force being applied to cable 20 when cable 20 is being pulled. When the force of pulling exceeds a predetermined force, palling fuse 40 will break and has to be reset before next use. Attached to the other end of pulling fuse 40 is a handle 50 used by cable installers to manually pull cable 20 into a desired position.

The onset of Category 6/7 standards has placed demands on manufacturers for even greater performance and bandwidth. Cables, such as Shielded Foiled Twisted Pair (SFTP) cables, have been developed to meet the increased demands. With SFTP cables, each twisted pair conductor is surrounded by a layer of aluminum foil. All the twisted pairs are covered by a layer of aluminum foil and a braided shield. Such configuration permits a higher transfer rate but is also more dependent on the precise positioning of twisted pair conductor within the insulating sheath.

The use of a pulling sock is not suitable for gripping SFTP cables for a number of reasons. Current pulling socks, such as pulling sock 30, are designed for gripping thick cables and it is physically difficult to make pulling socks small enough to grip narrower SFTP cables securely. In addition, the length of the cable gripped by the pulling sock has to be thrown away. This is because the gripping action of the pulling sock is likely to have displaced the conductors within the insulating sheath; thus, the part of the cable that has been gripped by the pulling sock may not be reliable anymore. Furthermore, the pulling sock is required to be relatively long in order to achieve a sufficient clamping force on the cable. This is because the steel lattice of the pulling sock only tightens around the cable as it is being pulled. If the pulling sock is too short, the cable may be pulled out of the pulling sock before the steel lattice had a chance to grip the cable properly. A longer pulling sock means that a large amount of cable will be wasted.

Consequently, it would be desirable to provide an improved apparatus for gripping cables.

### SUMMARY OF THE INVENTION

In accordance with a preferred embodiment of the present invention, an apparatus for gripping a cable includes an elongated housing for slidably receiving the cable axially. The housing is configured to permit the cable to form a loop by allowing an end of the cable to leave the housing and be received back by the housing. The apparatus for gripping cables also includes means for securing at least a part of the cable received back by the housing.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 graphically illustrates a cable gripper, according to the prior art;

FIGS. 2a-2b graphically depict a cable gripper in accordance with a preferred embodiment of the present invention;

FIG. 2c shows a longitudinal cross-section of the cable gripper from FIG. 2b before a second lock piece being tightened against a first lock piece;

FIG. 2d shows a longitudinal cross-section of the cable gripper from FIG. 2b after the second lock piece has been tightened; and

FIGS. 3a-3c depict a multi-puller for pulling multiple cables, in accordance with a preferred embodiment of the present invention.

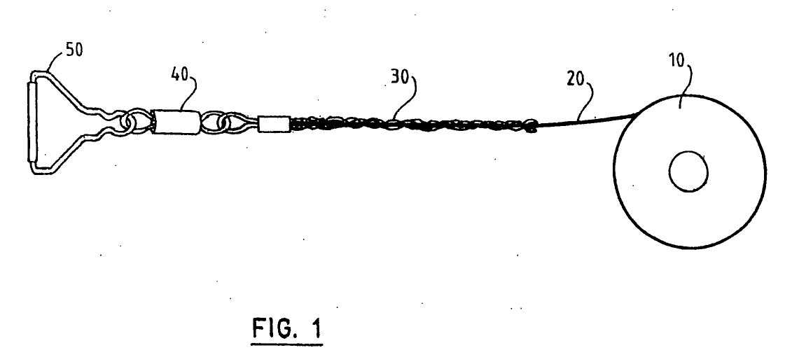

### DETAILED DESCRIPTION OF A PREFERRED EMBODIMENT

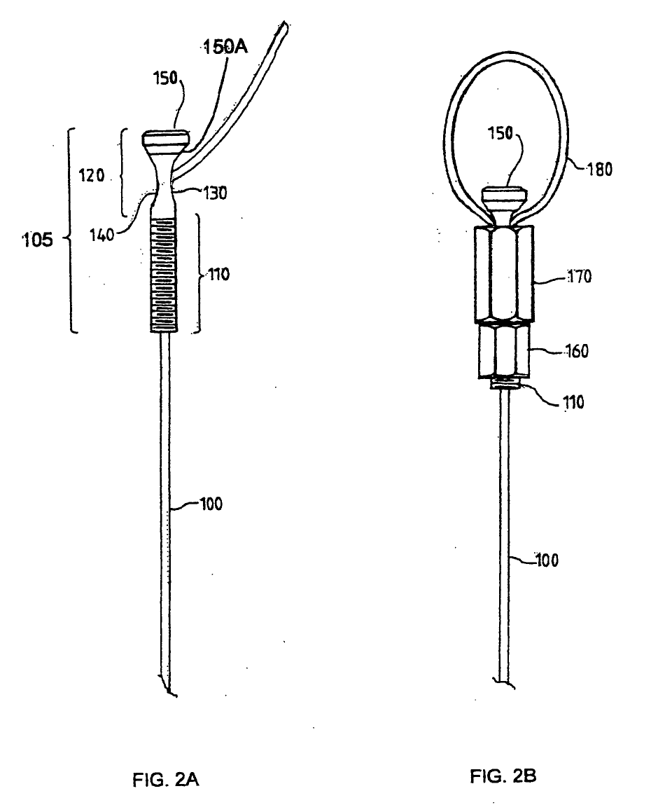

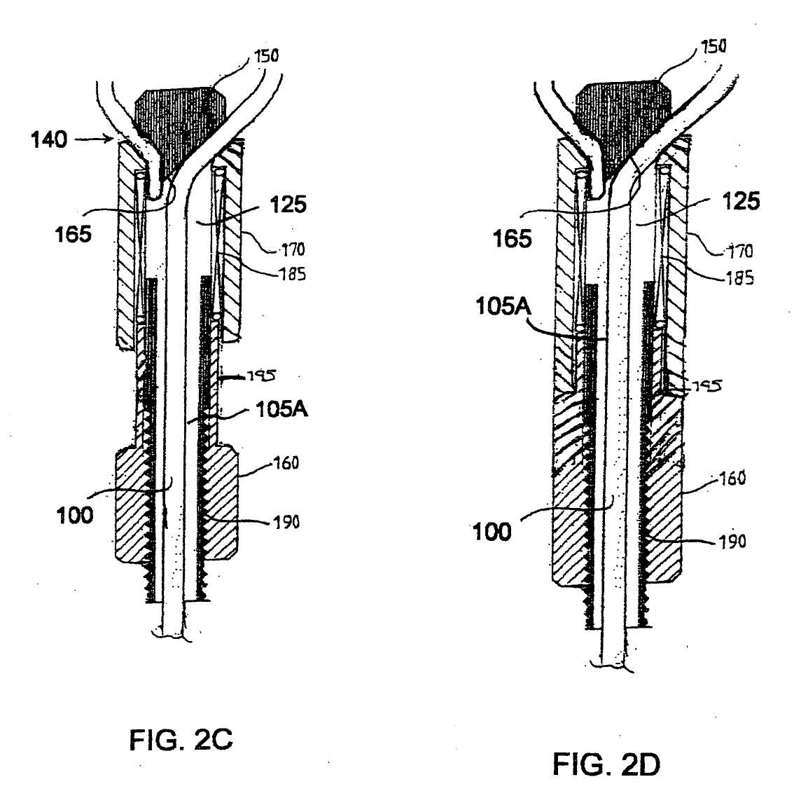

Referring to FIGS. 2a-2d, there are graphically illustrated an apparatus for gripping cables, in accordance with a preferred embodiment of the present invention. As shown, a cable gripper includes a housing having a hollow tubular body 105 for receiving a cable 100 axially within its central bore 105A. A lower portion 110 of body 105 is threaded. An upper portion 120 of body 105 has a head 150 with an angled under surface 150A and a transverse aperture 125 (see FIGS. 2c and 2d) that spans the full width of body 105. Aperture 125 has an exit 130 through which the free end of cable 100, which enters body 105 at its lower end remote from head 150 and travels up the center of body 105, can be pulled by a cable installer. Aperture 125 extends to an entrance 140 to permit the free end of cable 100 to be fed back into body 105 to form a loop 180. A ceiling 165 (FIGS. 2c and 2d) of aperture 125 is preferably slanted upwardly to an exit 130 so as to guide cable 100 out through exit 130.

A first lock piece 170 slides axially over body 105 to make contact with loop 180 at entrance 140 and exit 130 of aperture 125 to force cable 100 against angled surface 150A of head 150 at such points. A second lock piece 160 is threaded onto body 105 and can be tightened up against first lock piece 170 to clamp loop 180 in place.

As shown in FIG. 2c and 2d, a helical spring 185 is under compression between first lock piece 170 and second lock piece 160 so that first lock piece 170 is biased towards head 150. Thus, a force has to be applied to first lock piece 170 in a direction away from head 150 in order to be able to draw cable 100 out of exit 130 and to place the free end of cable 100 into entrance 140 of aperture 125 to form loop 180. Spring 185 sits on a tubular extension 195 of second lock piece 160. Once first lock piece 170 is released, spring 185 urges lock piece 170 back towards head 150 in order to temporarily hold cable 100 in place (as shown in FIG. 2c) until second lock piece 160 can be tightened on threads 190 to secure loop 180 (see FIG. 2d). Such effect of spring 185 means that tightening of second lock piece 160 can be performed single-handedly. Furthermore, spring 185 ensures that the resting position of first lock piece 170 is always up against head 150 and so dirt is prevented from entering the housing.

In an alternative embodiment (not shown), aperture 125 may not be extended fully across the width of body 105, but only from exit 130 to central bore 105A of body 105. A recess is formed in the side of body 105 opposite exit 130, such recess being located at where entrance 140 is shown in FIGS. 2a and 2c. During operation, the free end of cable 100 is tucked into the recess and clamped by first lock piece 170 as mentioned above. In addition, surface 150A and/or the top end of lock piece 170 is relieved in the vicinity of exit 130 so that cable 100 is only clamped at the free end tucked into the recess. This allows a cable installer to pull on cable 100 and for cable loop 180 to tighten around a device to which it is attached. Such variation can also be used where aperture 125 does extend across the full width of body 105; in that case, cable 100 is clamped only at entrance 140.

Since the predetermined breaking force is typically low when pulling more fragile cables (e.g., 4×4 pair cables pulled in by hand=125 N), the lighter the cable gripper the better. This is because a heavier cable gripper will encourage cable installers to exert more force during the pulling process. Thus, the cable gripper of the present invention is preferably made of a lightweight material such as aluminum.

Cable Installers will often need to pull in four cables at a time, each gripped by a pulling sock. The combined weight of the four pulling socks, adds to the force that needs to be exerted to pull the cables into position. However, if a great force is exerted, then the cables will be over stretched and the internal conductors can be damaged. As discussed above, a pulling fuse or similar device, which will break when a predetermined force is reached, is used by cable installers. After breakage, the pulling fuse has to be reset before the installation can continue.

When pulling in multiple cables simultaneously, it is also important to ensure that the pulling force exerted is symmetrical. Otherwise, it is difficult to ensure that the pulling fuse or similar device will break at the correct predetermined force in order to avoid over stretching the cable.

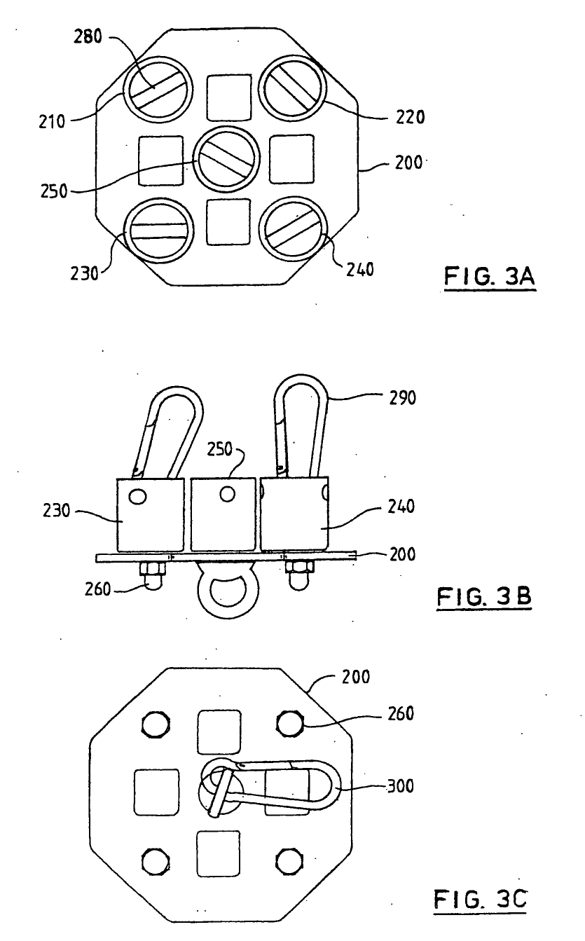

Referring now to FIGS. 3a-3c, there are illustrated a multi-puller for providing a symmetrical pulling force, in accordance with a preferred embodiment of the present invention. The multi-puller has an octagonal base 200. Four barrels 210, 220, 230 and 240 are placed symmetrically on base 200 around a center barrel 250. Each barrel is attached to base 200 by a swivel bearing 260 that permits each barrel to rotate freely about an axis normal to base 200. The spacings of barrels 210, 220, 230 and 240 are chosen so as to ensure that they do not interfere with one another during operation.

A screw pin 280 is fixed across the diameter of each barrel and provides a point around which a quick release loop 290 is attached. The cable loop formed from using the cable gripper of the present invention is looped over loop 290 to attach itself to the multi-puller. The underside of base 200 (as shown in FIG. 3c) has a single quick release loop 300 attached thereto in register with center barrel 250. During operation, quick release loop 300 is attached to a pulling fuse or similar device. Quick release loop 300 may also be attached directly to a handle or pulling rope.

The positioning of the number of cables being pulled determines the choice of barrels. For example, a cable installer pulling four cables should use barrels 210, 220, 230 and 240, shown in FIG. 3a. On the other hand, if only three cables are being pulled, then barrels 210, 250, and 240 or barrels 220, 250 and 230 should be used. Because the barrels can swivel freely, the cable is less likely to the barrels is chosen such that a symmetrical pulling force can be achieved no matter how many cables (up to a maximum of five in the present embodiment) are pulled in. A symmetrical pulling force needs to be used when pulling a cable because twisted cable can hamper installation and can damage the cable itself.

As has been described, the present invention provides an improved apparatus for gripping cables. The cable gripper of the present invention provides a simple but effective way of attaching a cable to a pulling fuse or similar device. Unlike the usage of a pulling sock, the cable gripper of the present invention is adapted to work with the newer type of cables. Furthermore, much less cable is damaged by the cable gripper of the present invention than with the pulling sock. Only the part of the cable (at least initially) used to form a loop is needed to be thrown away, as opposed to the entire length of cable inside the pulling sock needs to be discarded. This is due to the way in which the cable is secured to allow a device to be far shorter than the pulling sock, whilst still achieving enough of a clamping force on the cable. The pulling sock is necessarily of a far greater length in order to securely grip a cable. This is because the steel lattice of the pulling sock only tightens around a cable as it is being pulled. If the pulling sock was any shorter, the cable may be pulled out of the pulling sock before the steel lattice had a chance to grip the cable properly.

The cable gripper of the present invention is particularly advantageous because the attachment means is the cable itself (i.e., loop 180). Using the cable loop as an attachment means is particularly advantageous. This reduces the number of parts that need to be supplied with the cable gripper. It is important when multiple cables are pulled that a symmetrical pulling force is exerted and that the tension on each cable is substantially identical. This is because, as previously mentioned, the cables are likely to be damaged if over stretched. Therefore a pulling fuse or similar device is used that will break if a predetermined force is applied during the pulling process and thus prevent the application of an excessive force. In order to ensure that the device severs at the correct point in time, the force applied is required to be a symmetrical one.

The present invention also provides a device for pulling multiple cables. The device includes a base and means for attaching each of the cables to a base. The attachment means includes a first central attachment device and an even number of further attachment devices symmetrically surrounding the central device.

Cable has a memory and can become twisted during the installation process. This can slow the process and can potentially lead to damage to the cable due to displacement of the internal conductors. Therefore, each attachment means is freely rotatable about the base and thus can move with the cable. Each attachment means also includes a quick-release loop to make their use as easy as possible.

While the invention has been particularly shown and described with reference to a preferred embodiment, it will be understood by those skilled in the art that various changes in form and detail may be made therein without departing from the spirit and scope of the invention.

1. An apparatus for gripping a cable, said apparatus comprising:
an elongated housing for slidably receiving a cable axially thereof, said housing being configured to permit an end of said cable to leave said housing and be received back by said housing to form a cable loop; and
means for securing a part of said cable received back by said housing.

2. The apparatus of claim 1, wherein said housing is tubular having a central bore for allowing said cable to pass through.

3. The apparatus of claim 2, wherein said housing has an aperture that opens on one side of said housing to allow said cable to leave said housing through said aperture.

4. The apparatus of claim 3, wherein said housing has a recess on said at least one side of said housing opposite said aperture opening for receiving said end of said cable.

5. The apparatus of claim 3, wherein said aperture extends fully across a width of said housing to open in opposite sides of said housing such that said cable can leave said housing through one end of said aperture and being received back by said housing through another end of said aperture.

6. The apparatus of claim 3, wherein a ceiling of said aperture is slanted to guide said cable out through said aperture.

7. The apparatus of claim 1, wherein said means for securing said cable loop further includes a first lock piece for temporarily holding said cable loop against a head, and a second lock piece for securing said first lock piece against said cable loop.

8. The apparatus of claim 7, wherein said means for securing further includes biasing means for biasing said first lock piece towards said head.

9. An apparatus for pulling a plurality of cables, said apparatus comprising:
a base;
means for attaching each of said plurality of cables to said base, wherein said means for attaching includes a first central attachment apparatus and an even number of further attachment apparatuses symmetrically surrounding said central apparatus.

10. The apparatus of claim 9, wherein each attachment apparatus is freely rotatable about an axis normal to said base.

11. The apparatus of claim 9, wherein each attachment apparatus includes a quick-release loop.
